(19) United States
(12) Patent Application Publication
(10) Pub. No.: US 2013/0248297 A1
(43) Pub. Date: Sep. 26, 2013

(54) SLACK SENSOR FOR A STORAGE LIBRARY

(71) Applicants: Joseph Paul Manes, Arvada, CO (US); Daniel James Plutt, Superior, CO (US)

(72) Inventors: Joseph Paul Manes, Arvada, CO (US); Daniel James Plutt, Superior, CO (US)

(73) Assignee: ORACLE INTERNATIONAL CORPORATION, Redwood City, CA (US)

(21) Appl. No.: 13/424,686

(22) Filed: Mar. 20, 2012

(51) Int. Cl. B66B 5/12; B66B 11/04

(52) U.S. Cl. 187/254; 254/277

(57) ABSTRACT

Systems and methods are described for providing sensing slack on cabling coupled between a drive mechanism and a carriage. Embodiments of the carriage are configured so that the cables are substantially in tension when Z-directional movement of the carriage is substantially unimpeded and at least one cable manifests slack when Z-directional movement is impeded. Accordingly, detecting slack on the cables can be used to detect impedance to Z-directional movement of the carriage. According to some embodiments, a novel slack sensor translates tension on the cables into a forward pulling force that holds the slack sensor in a deactivated state. A reverse force is maintained on the slack sensor in a magnitude and direction that causes the slack sensor to move to an activated state whenever sufficient tension is not manifest on the cables. Slack can thus be detected by detecting when the slack sensor is in its activated state.

### FIELD

Embodiments relate generally to data storage systems, and, more particularly, to slack sensing in storage libraries.

### BACKGROUND

Storage library systems are often used by enterprises and the like to efficiently store and retrieve data from storage media. In the case of some storage libraries, the media are data cartridges (e.g., tape cartridges) that are typically stored and indexed within a set of magazines. When particular data is requested, a specialized robotic mechanism finds the appropriate cartridge, removes the cartridge from its magazine, and carries the cartridge to a drive that is designed to receive the cartridge and read its contents. Some storage libraries have multiple drives that can operate concurrently to perform input/output (10) operations on multiple cartridges.

To operate properly, the robotic mechanisms are expected to reliably (e.g., repeatably and accurately) and rapidly find, retrieve, and deliver desired cartridges throughout the storage library cartridge inventory. This functionality can be facilitated by configuring the robotic mechanism to move a hand assembly in at least three axes (e.g., x, y, and Z-directions, and sometimes one or more of pitch, roll, or yaw), and to include one or more sensors to reliably detect the position and/or orientation of the hand assembly. When in its desired location, the hand assembly is activated to reliably grip the desired cartridge and remove it from a magazine or drive, or to reliably release the cartridge into a desired magazine slot or drive.

Different implementations of storage library systems move robotic mechanism in the Z-direction (i.e., vertically with respect to the cartridge inventory) in different ways. Some implementations may use gears, tracks, belts, hydraulics, or other such control mechanisms. Other implementations associate the robotic mechanism with a platform or carriage that is held up by cables, or the like. By pulling on the cables (e.g. using pulleys, etc.), the platform or carriage can be lifted; and by adding slack to the cables, the platform or carriage can be allowed to move in a downward direction under the force of gravity (e.g., in a substantially floating manner). In such implementations, it may be important to detect any snags in the downward motion of the platform or carriage that could impact reliability of placement and/or orientation of the robotic mechanism.

### BRIEF SUMMARY

Among other things, systems and methods are described for sensing slack on cabling coupled between a drive mechanism and a carriage. The carriage is configured to move at least in a Z-direction in context of a structural framework in such a way that the cables coupled with the carriage are substantially in tension when Z-directional movement of the carriage is substantially unimpeded. For example, the carriage may be a platform assembly used to transport a robotic mechanism in context of a data storage system. Impedance to the Z-directional movement of the carriage (e.g., due to a portion of the carriage snagging on a feature of the structural framework) may manifest as slack in one or more of the cables. Accordingly, detecting slack on the cables can be used to detect impedance to Z-directional movement of the carriage. Embodiments provide novel techniques for sensing slack on the cables. In some implementations, a slack sensor is designed so that tension on the cables is translated into a forward pulling force that holds the slack sensor in a deactivated state. A reverse force is maintained on the slack sensor in a magnitude and direction that causes the slack sensor to move to an activated state whenever sufficient tension is not manifest on the cables. Slack can thus be detected by detecting when the slack sensor is in its activated state.

According to one set of embodiments, a system is provided for slack sensing. The system includes a forward tensioner in mechanical communication with a cable and configured to manifest a deactivated state when the cable is manifesting a tension condition and an activated state when the cable is manifesting a slack condition; a reverse tensioner configured to apply a reverse force on the forward tensioner; a forward cable delivery subsystem configured to translate tension on the cable into a forward force acting on the forward tensioner in such a way that the forward force is of a magnitude sufficient to overcome the reverse force applied by the reverse tensioner when the cable is manifesting the tension condition and insufficient to overcome the reverse force applied by the reverse tensioner when the cable is manifesting the slack condition; and a slack detector configured to detect when the forward tensioner is in the activated state.

According to another set of embodiments, a carriage transport system is provided. The system includes: a structural framework; a carriage configured to travel in a Z-direction in context of the structural framework; a Z-drive subsystem having a number of cables coupled with the carriage in such a way that the plurality of cables are in tension when Z-directional movement of the carriage is substantially unimpeded, and a drive mechanism configured to move the carriage in the Z-direction using the cables; and a slack sensing subsystem in mechanical communication with at least one of the cables and configured to detect that the Z-directional movement of at least a portion of the carriage is being impeded by detecting slack on the at least one of the cables.

According to yet another set of embodiments, a method is provided for controlling Z-directional movement of a carriage in context of a structural framework. The method includes: detecting, while using a Z-drive subsystem to move a carriage in a Z-direction, that the Z-directional movement of at least a portion of the carriage is being impeded by detecting slack on at least one of a plurality of cables coupled between the carriage and the Z-drive subsystem in such a way that the plurality of cables is substantially in tension when Z-directional movement of the carriage is substantially unimpeded; and directing the Z-drive subsystem to adjust the Z-directional movement of the carriage in response to the detecting step.

### BRIEF DESCRIPTION OF THE DRAWINGS

The present disclosure is described in conjunction with the appended figures:

FIG. 1 shows a block diagram of an illustrative rack-mounted storage library, to provide a context for various embodiments;

FIGS. 2A and 2B show rear and front views, respectively, of an illustrative base module, according to various embodiments;

FIGS. 3A and 3B show rear and front views, respectively, of an illustrative expansion module, according to various embodiments;

FIG. 4A shows a view looking down on the underside of an illustrative robot CRU (customer replaceable unit), according to various embodiments;

FIG. 4B shows another view looking up at the underside of an illustrative robot CRU with the Z-platform assembly partially lowered, according to various embodiments;

FIG. 5 shows a block diagram of an illustrative slack sensing environment, according to various embodiments;

FIGS. 6A and 6B show two views of the same partial environment to demonstrate operation of an illustrative slack sensing subsystem in its deactivated and activated states, respectively, according to various embodiments;

FIG. 7 shows an illustrative structural framework within which a Z-platform assembly can be raised and lowered using cabling and slack in the cabling can be detected using slack sensing subsystems implemented according to various embodiments;

FIG. 8A shows a side view of the structural framework of FIG. 7 in which one of the slack sensing subsystems is revealed;

FIG. 8B shows a close-up view of the slack sensing subsystem revealed in FIG. 8A;

FIG. 8C shows a similar side view of the structural framework as shown in FIG. 8A with the same slack sensing subsystem revealed, but with the cabling manifesting slack;

FIG. 8D shows a close-up view of the slack sensing subsystem revealed in FIG. 8C; and

FIG. 9 shows a flow diagram of an illustrative method for detecting slack, according to various embodiments.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

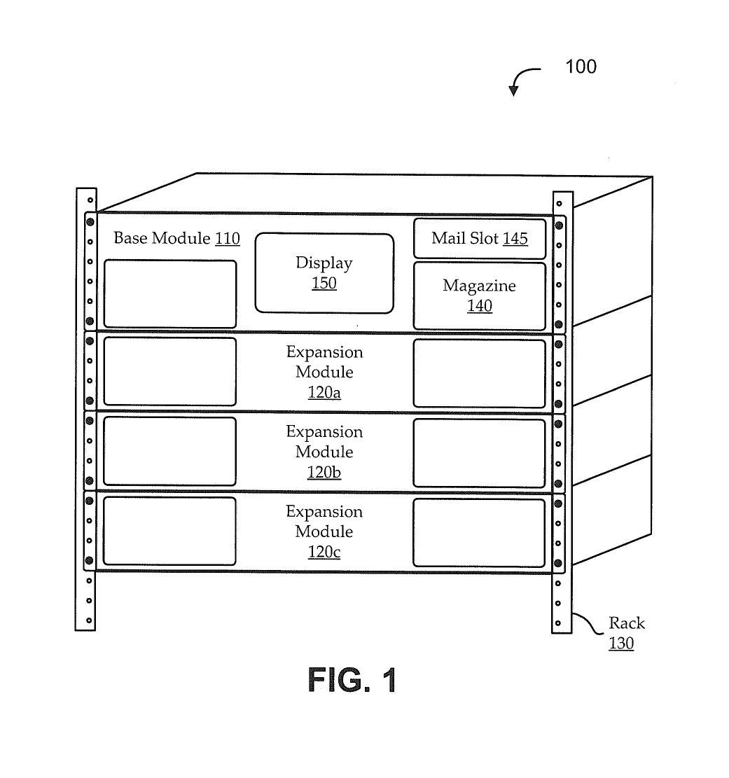

For the sake of context, FIG. 1 shows a rack-mounted storage library 100 for use with various embodiments. The storage library 100 includes a base module 110 and one or more expansion modules 120, configured to be mounted in an equipment rack 130 (only the mounting rails of the equipment rack 130 are shown for simplicity). The base module 110 and expansion modules 120 provide physical storage for multiple storage media cartridges (e.g., tape cartridges) in magazines 140. Embodiments also include one or more media drives (e.g., tape drives), controllers, power supplies, indicators, communications subsystems, and/or other functions. As will be discussed more fully below, the storage library 100 also includes a robotic mechanism for finding and ferrying storage media cartridges between locations within the storage library 100 (e.g., magazines 140 and drives).

According to an illustrative embodiment, the storage library 100 is a small, rack-mounted, automated tape library. The base module 110 is “3 RU” high (three standard rack units, or approximately 5.25-inch high) and includes one robotic mechanism. Up to nine additional, “2 RU” high (approximately 3.5-inch high) expansion modules 120 can be added to provide additional drive and/or magazine 140 slot capacity, so that a maximum configuration of one base module 110 and nine expansion modules 120 has a total height of “21 RU,” or half of a standard equipment rack 130. The single robot mechanism is configured to access all magazine 140 slots and drives in the base module 110 and all expansion modules 120.

In the illustrative embodiment, each of the base module 110 and the expansion modules 120 can house up to two half-height or one full-height LTO5 tape drives. Each of the base module 110 and the expansion modules 120 can also house two removable magazines 140, each having fifteen cartridge slots. In some implementations, the storage library 100 can be divided into partitions each associated with, for example, at least one drive and at least one magazine 140. Each partition can be configured to behave as an independent library, notwithstanding that all partitions share the single robotic mechanism (e.g., partitions can be commanded as independent libraries for tape operations, while sharing many resources for service and administration). Some implementations also include a “mailslot” 145 in the base module 110, as discussed below.

Some embodiments provide local and remote management of various functions through graphical user interfaces (GUI). In one implementation, the local interface GUI is displayed on a seven-inch, front-mounted, touch-screen panel display 150. The remote interface may be implemented as a browser-based interface (BUI), accessible by connecting a web browser to the library's Internet protocol (IP) address.

Some embodiments are configured to be installable and serviceable by end customers to the greatest extent practical. For example, an installation wizard may be provided to simplify initial installation, a simple rack rail system for base modules 110 and expansion modules 120 will allow two people without any mechanical assistance (e.g. lift) to easily install the modules on an equipment rack 130. In some such embodiments, most replaceable library components will be Customer Replaceable Units (CRUs) (i.e., as opposed to field replaceable units (FRUs), which are serviceable and/or replaceable only by trained technicians). For example, certain implementations allow almost all installation, maintenance, upgrades, and/or normal use of the storage library 100 to be performed with only front and rear access to the equipment rack 130 and few or no tools.

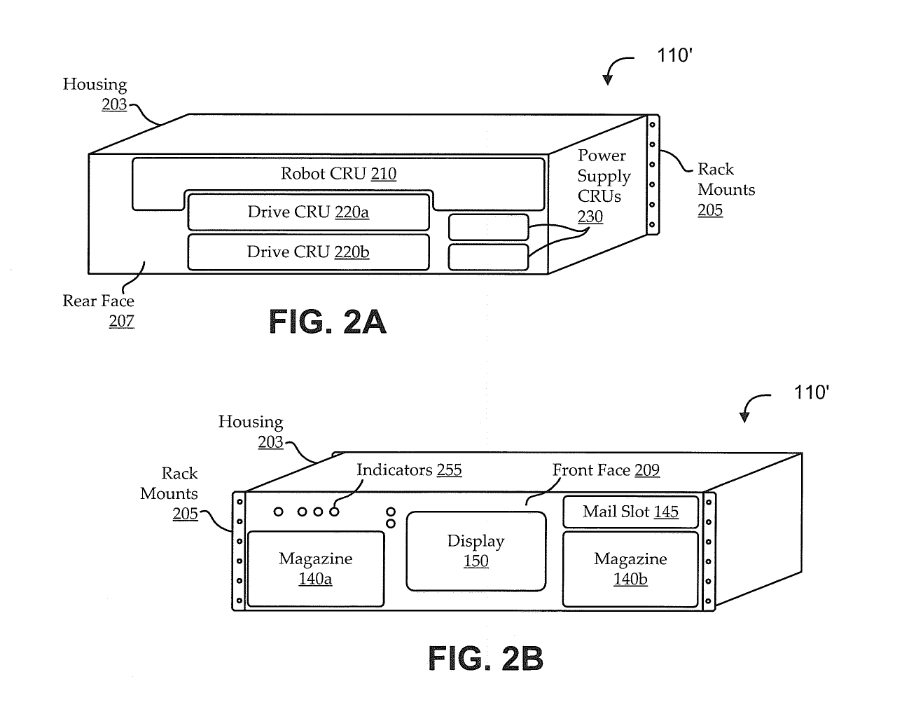

FIGS. 2A and 2B show rear and front views, respectively, of an illustrative base module 110′, according to various embodiments. The illustrative base module 110′ may be an implementation of base module 110 of FIG. 1. As shown, the base module 110′ includes a housing 203 (e.g., a chassis) configured with rack mounts 205 for mounting to an equipment rack (e.g., as shown in FIG. 1). A rear face 207 and a front face 209 are also shown as part of the housing 203. As discussed above, embodiments such as the one illustrated as base module 110′, are designed to facilitate customer serviceability. Accordingly, most of the replaceable components are shown as accessible from the front and rear exterior of the base module 110′, which would be substantially exposed when mounted in a standard equipment rack.

Looking at the rear view of the base module 110′ in FIG. 2A, access is provided to a robot CRU 210, one or more drive CRUs 220, and one or more power supply CRUs 230. As will be described more fully below, the robot CRU 210 is configured to house the robotic mechanism and supporting components (e.g., mechanical drive modules, control hardware and software modules, configuration memory, etc.). Traditional storage library systems typically are configured so that the robotic mechanisms are only serviceable by highly trained personnel, and even removing the mechanism to send out for off-site servicing requires training, specialized tools, or the like. The ability to replace the entire robotic mechanism and all its supporting components in a single CRU is a novel improvement over traditional implementations. For example, implementations allow a customer to simply pop out a broken robot CRU 210 using a couple of thumb screws, slide in a replacement CRU, and reinitialize the system, without waiting for a technician to troubleshoot and fix any issues.

Embodiments of the drive CRUs 220 are media drive modules that can be removed by an end consumer. Various implementations support standard, half-height or full-height tape drives. As described more fully below, the port in the drive for receiving a media cartridge faces into the base module 110′, so that media cartridges can only be inserted and/or removed by the robotic mechanism within the confines of the housing 203. In some implementations, one or more “external” media drives may be provided to facilitate troubleshooting and the like.

Embodiments of the power supply CRUs 230 include any useful type of power supply components for supplying power to the base module 110′ and or to any other components (e.g., to one or more expansion modules 120 (not shown)). For example, the power supply CRUs 230 can include power generators, power converters, power conditioners, back-up batteries and/or other power duplication, switches, input and/or output ports, indicators, and the like. In some implementations, each power supply CRU 230 includes a male, three-prong connector for interfacing with line power and a main power switch. Some embodiments include a power supply CRU 230 for each drive CRU 220 (i.e., if the base module 110′ has only a single drive CRU 220, it may also only have a single power supply CRU 230 to support the drive). In other embodiments, a second power supply CRU 230 is used as a backup supply to the first power supply CRU 230, and may be coupled with a different power source.

In one implementation, the base module 110′ has slots for two power supplies (e.g., two power supply CRUs 230). These can be implemented as custom power supplies, for example, having an input voltage of 100-250 volts AC at 50-60 Hertz, and an output voltage of twelve volts DC switched plus five volts DC standby power. For example, the power supplies may be sized to run two tape drives plus robotics and any other sensors, etc. (e.g., with or without redundancy). Typically, the base module 110′ has at least one power supply, even if no drives are included, to support the main processor, interface functionality (e.g., the display 150), etc.

Looking at the front view of the base module 110′ in FIG. 2B, access is provided to a display 150, one or more magazines 140, and a mailslot 145. One or more indicators 255 may also be provided to show certain operational states, and the like (note that the sizes, numbers, positions, etc. of the indicators shown are intended only to be illustrative). In various implementations, base module 110 has overall library status indicators on the front and back of the module, along with a locate switch which activates the front and back locate LEDs; powered CRUs may have their own status indicators; hot-swappable CRUs can have indicators that show when the CRUs can be safely removed; power supplies and tape drives can have additional indicators; an “AC present” indicator can be provided to stay on even when the storage library is off (as long as AC power is connected). In one embodiment, a set of primary indicators include “locate,” “fault,” and “OK” indications. Next to the primary indicators are secondary indicators specific for the operator panel that indicate the status of the operator panel (e.g., an operator panel CRU, if implemented as such).

Other types of indications and status can also be provided using the display 150. Embodiments of the display 150 are used to facilitate various functionality through a local graphical user interface (GUI), including, for example, IO functions, service and diagnostic functions, etc. In one implementation, the display 150 is a seven-inch, front-mounted, touch-screen panel (e.g., an LCD touch panel display with a WVGA (wide VGA) 800×480 pixel screen equipped with a resistive or capacitive touch-sensitive overlay).

Each magazine 140 can be configured to hold multiple (e.g., up to fifteen) cartridges in such a way as to be reliably accessed by the robotic mechanism. For example, the magazines 140 can be designed to have features to aid in targeting, location, and or other functions of the robotic mechanism; features that securely hold the cartridges in place, while allowing for easy release of the cartridges to a robotic gripper when desired; features to add strength to the magazines 140 (e.g., to reduce sag, increase usable life, etc.) and/or to reduce weight; etc.

Embodiments of the mailslot 145 (or “Cartridge Access Port” (CAP)) include a special type of magazine designed to act as a controlled interface between the human user and the robotic mechanism. To add or remove cartridges from the storage library, a user ejects the mailslot 145 from the base module 110′ and is presented with a number of cartridge slots (e.g., four “Import/Export cells” (“I/E cells”)). The user can then insert cartridges into, or remove cartridges from, these slots without interfering with robotic mechanism's operations. In some implementations, the robotic mechanism is used to activate a latch internal to the base module 110, thereby allowing the user to remove the mailslot 145 only when the robotic mechanism is in an appropriate condition (e.g., parked in the robot CRU 210). Certain embodiments having data partitions (as discussed above) only allow one partition at a time to make use of the mailslot 145.

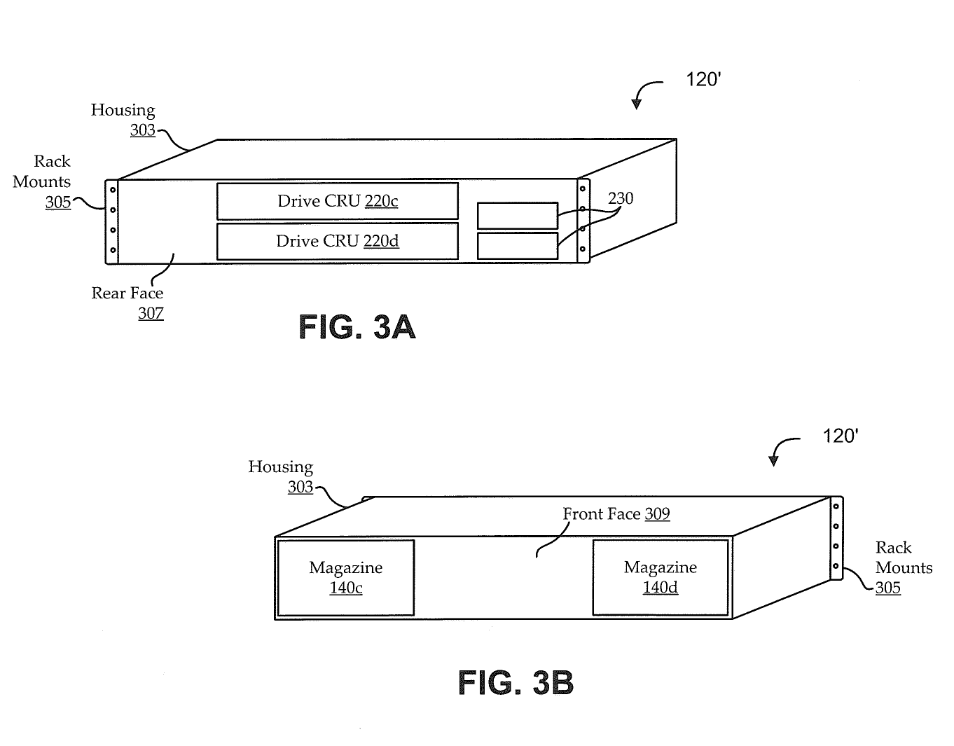

FIGS. 3A and 3B show rear and front views, respectively, of an illustrative expansion module 120′, according to various embodiments. The illustrative expansion module 120′ may be an implementation of expansion module 120 of FIG. 1. As shown, the expansion module 120′ includes a housing 303 (e.g., a chassis) configured with rack mounts 305 for mounting to an equipment rack (e.g., as shown in FIG. 1). A rear face 307 and a front face 309 are also shown as part of the housing 303. As with the base module 110′ of FIGS. 2A and 2B, the expansion module 120′ is designed to facilitate customer serviceability. Most of the replaceable components are shown as accessible from the front and rear exterior of the expansion module 120′, which would be substantially exposed when mounted in a standard equipment rack.

In the embodiment shown, various aspects of the expansion module 120′ are similar or identical to the base module 110′. For example, embodiments of the expansion module 120′ do not typically have a robot CRU 210, display 150, or mailslot 145, as they are configured to exploit that functionality from the base module 110′ components. However, like the base module 110′, the expansion module 120′ includes one or more drive CRUs 220 and one or more power supply CRUs 230 configured to be accessed from the rear side of the expansion module 120′, and one or more magazines 140 configured to be accessed from the front side of the expansion module 120′. In some embodiments, the drive CRUs 220, power supply CRUs 230, and/or magazines 140 of the expansion module 120′ are the same as those implemented in the base module 110′.

Because of the lack of certain features in embodiments of the expansion module 120′ (e.g., there may be no robot CRU 210, no main processor, etc.), expansion module 120′ power requirements may be different from those of the base module 110. In certain implementations, the expansion modules 120′ still have slots for two power supplies (e.g., two power supply CRUs 230), which can be implemented as the same power supplies used in the base module 110 (e.g., to avoid having to support or source multiple types of power supplies). However, the power supplies of the base module 110 may provide more power than is needed to run configurations of the expansion modules 120′. For example, a single power supply may be able to support an expansion module 120′ even with two drives, and it is possible to implement an expansion module 120′ with no drives and no power supplies. Alternatively, two power supplies may still be used, for example, to provide redundancy.

As discussed above, the base module 110′ and expansion modules 120′ include a number of components that can be designed for customer replaceability, including the robot CRU 210, drive CRUs 220, power supply CRUs 230, and magazines 140. It is worth noting that, even though these components may be accessible and replaceable by customers, embodiments may still be configured to prevent (or mitigate) undesirable interference with those components. As one example, those replaceable components typically are installed in a physically secure manner (e.g., using latches, thumbscrews, removable faceplates, and/or other techniques) to provide relatively easy access when needed, while mitigating inadvertent access (e.g., accidental removal of a magazine 140 during operation). As another example, certain embodiments may allow a drive CRU 220 to be removed during operation of the storage system, so long as the drive is not actively in use (e.g., by using a drive eject or park command, or other technique). As still another example, removal of the robot CRU 210 or magazines 145 may be prevented until certain operations have been completed (e.g., the robotic mechanism is parked within the base module 110′, etc.).

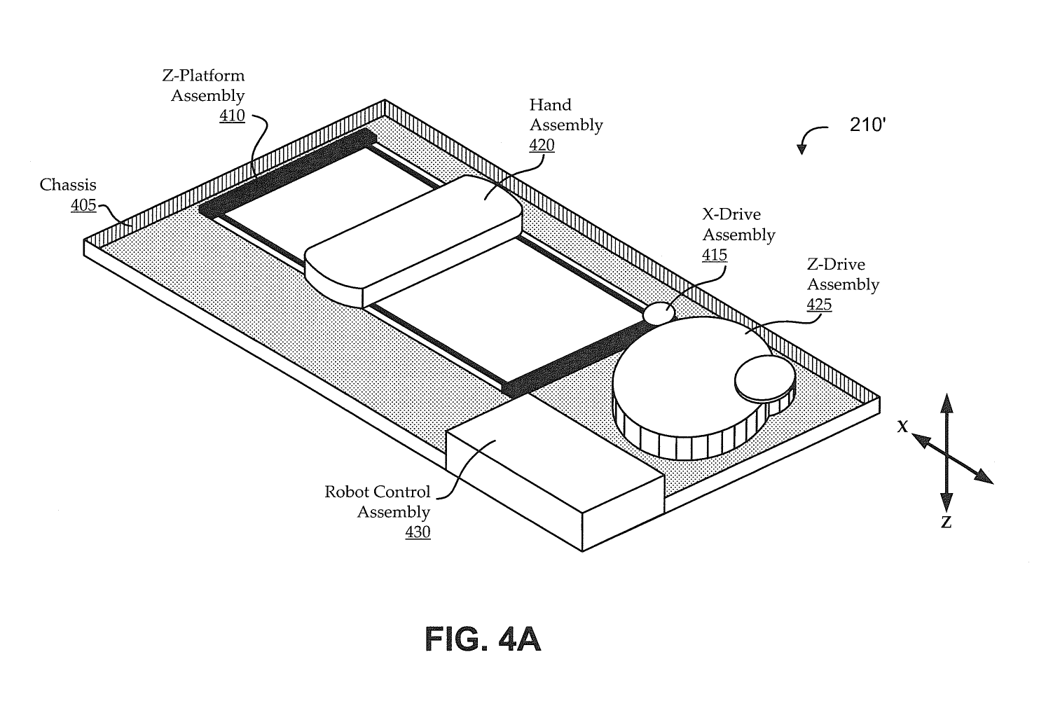

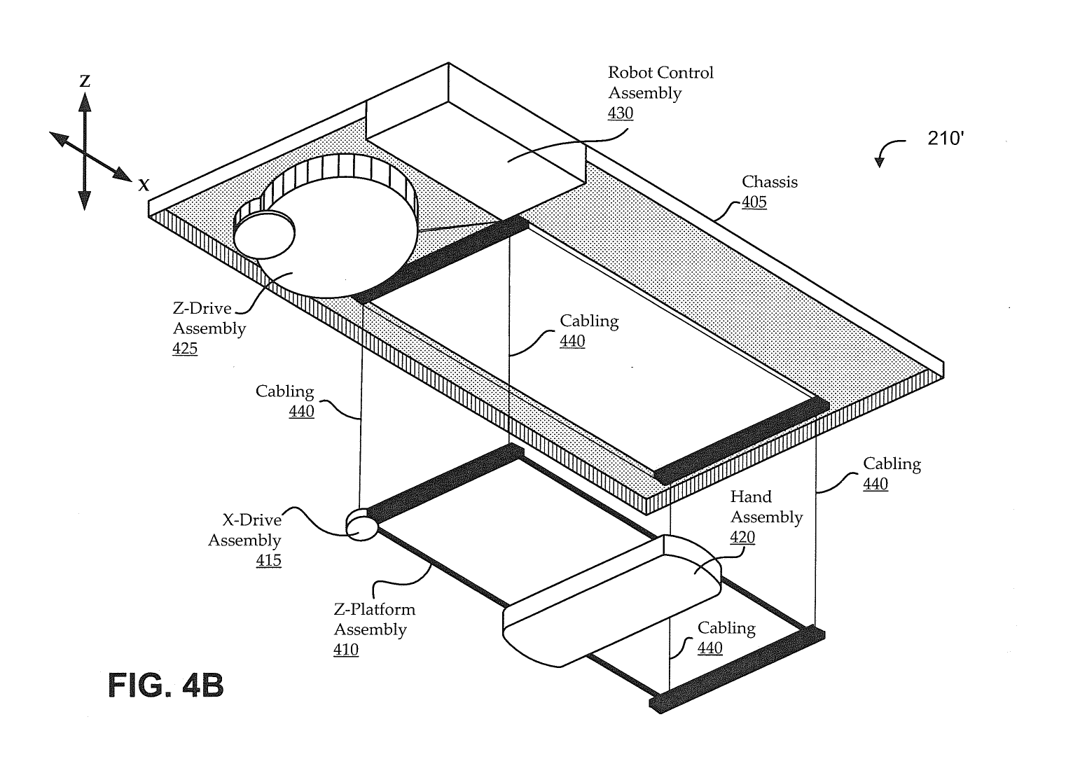

Much of the functionality of storage systems, like those discussed above with reference to FIGS. 1-3B, is facilitated by the robotic mechanism. As discussed above, the robotic mechanism is used to locate cartridges and ferry them between magazine slot locations and media drives. FIGS. 4A and 4B illustrate two views of an illustrative robot mechanism implemented as part of a robot CRU 210. The illustrations and descriptions of the robotic mechanism are highly simplified and represent only on possible type of implementation. Accordingly, they are intended only to add clarity and context and should not be construed as limiting the scope of the invention.

Turning to FIG. 4A, a view is shown looking down on the underside of an illustrative robot CRU 210′, according to various embodiments. The robot CRU 210′ may be an implementation of the robot CRU 210 of a base module 110, as discussed with reference to FIG. 2A. The robot CRU 210′ includes a chassis 405 that houses a Z-platform assembly 410, an X-drive assembly 415, a hand assembly 420, a Z-drive assembly 425, and a robot control assembly 430.

In the implementation shown, the robotic mechanism is configured to move from its “home” position in the robot CRU 210′ of the base module 110′ down and/or over to any magazine 145 slot or drive in the base module 110′ or an expansion module 120′. To accomplish this type of motion, the hand assembly 420 of the robotic mechanism moves in at least a “Z” direction (for the sake of FIGS. 4A and 4B, the +Z-direction is up towards the home position in the robot CRU 210, and the −Z-direction is down towards the bottom-most magazine slots of the bottom-most expansion module 120′) and an “X” direction (for the sake of FIGS. 4A and 4B, the +X direction is towards the front side of the base module 110′ or expansion modules 120′, and the −X direction is towards the rear side of the base module 110′ or expansion modules 120′).

The hand assembly 420 is coupled with the Z-platform assembly 410, which can be moved in the Z-direction (i.e., raised and lowered) by the Z-drive assembly 425. The hand assembly 420 is also able to move along the Z-drive assembly 425 in the X-direction by the X-drive assembly 415 (e.g., along rails that are substantially perpendicular to the Z-directional axis). The Z-drive assembly 425 and X-drive assembly 415 may include any hardware for providing the desired movements, such as cables, gears, belts, rails, wheels, bearings, etc. Embodiments provide other types of motion in other ways. Some embodiments of the hand assembly 420 are coupled to the Z-platform assembly 410 via a “wrist” mechanism (not shown) that provides motion in a yaw direction (i.e., around the Z-directional axis). Some embodiments of the hand assembly 420 further provide radial movement from the Z-directional axis. For example, a grabber mechanism can “reach out” in a radial direction that is determined by the yaw (rotational) orientation provided by the wrist mechanism.

These various types of motion of the robotic mechanism, as well as other functionality of the robotic mechanism, are handled at least in part by the robot control assembly 430. Embodiments of the robot control assembly 430 are effectively the “brains” of the robotic mechanism, including electronic components used to store calibration information for the robotic mechanism, control movements of the robotic mechanism, read and/or decipher sensor information retrieved from the robotic mechanism, etc. For example, if data from a particular cartridge is desired, the robot control assembly 430 may direct the robotic mechanism to move to the magazine slot associated with that cartridge, verify presence of the cartridge, retrieve the cartridge from the magazine, ferry the cartridge to a drive, and release the cartridge into the drive.

For added clarity, FIG. 4B shows another view looking up at the underside of an illustrative robot CRU 210′ with the Z-platform assembly 410 partially lowered, according to various embodiments. As illustrated, the Z-platform assembly 410 may not have a solid platform, and may instead be implemented as a carriage having a number of structural members (e.g., rails, supports, etc.). In the particular embodiment shown, the Z-drive assembly 425 includes motors and gearing that drive a bullwheel. The Z-platform assembly 410 is coupled with the bullwheel using a cable and pulley system. For example, cabling 440 is attached at each corner of the Z-platform assembly 410. The four cables 440 pass through pulleys and wrap around the bullwheel. Turning the bullwheel in one direction or the other adds slack to, or removes slack from, the cables 440, causing the Z-platform assembly 410 to be raised or lowered. Once in its desired Z-position (or while moving to that position), the X-drive assembly 415 can be used to move the hand assembly 420 (e.g., along rails of the Z-platform assembly 410) to a desired X-location. Once in its desired X-Z-position (or while moving to that position), the hand assembly 420 can be turned (e.g., using a wrist mechanism) to a desired rotational orientation (e.g., to face a cartridge slot or a media drive, to provide a desired angle for use of a sensor, etc.). If desired, a gripper mechanism may then be used to reach out (i.e., radially) from that X-Z-position and rotational orientation (e.g., to grab or release a cartridge).

It will be appreciated that in embodiments, such as the one shown in FIG. 4B, the Z-platform assembly 410 moves in the Z-direction in a substantially free-floating manner. As the Z-platform assembly 410 is raised or lowered on its cables 440, tension may be maintained on the cables 440 as a result of gravity acting on the Z-platform assembly 410. For example, a system of pulleys and gears (e.g., a bullwheel) are used to add tension to the cables, thereby lifting the Z-platform assembly 410. The same system of pulleys and gears is used to reduce tension on the cables, thereby allowing the Z-platform assembly 410 to fall in a controlled manner under the force of gravity. If the Z-platform assembly 410 is allowed to fall under the force of gravity as desired, the cables will be held in tension under the weight of the Z-platform assembly 410. If, however, an attempt is made to lower the Z-platform assembly 410 by releasing cable tension, and the attempt is unsuccessful (e.g., one or more locations on the Z-platform assembly 410 snags on a feature of a module, magazine, cartridge, drive, etc.), one or more of the cables will manifest slack.

Embodiments provide novel slack sensing functionality, for example, for detecting slack in one or more of the cables attached to the Z-platform assembly 410. Indeed, there are many ways to detect a snag in the lowering of the Z-platform assembly 410. For example position sensors, accelerometers, tilt sensors, etc. can be used to detect that the Z-platform assembly is not moving, positions, and/or oriented as expected. However, these approaches can tend to add cost and/or complexity to certain implementations.

Embodiments described herein integrate a mechanical subassembly into the cabling system that uses counter tension (e.g., spring tension) to manifest a first state when a cable passing through the subassembly is in tension and a second state when the cable passing through the subassembly is not in tension. Notably, lowering the Z-platform assembly 410 may involve releasing additional cable length, which may be referred to herein as releasing cable tension or adding slack to the cabling. However, so long as the Z-platform assembly 410 is allowed to substantially hang (i.e., without any portion of the platform snagging on any features), the cables should remain “in tension.” In that condition, any slack added to the cables is immediately “taken up” by gravitational (or similar) forces, so that the slack will not manifest in the cables. It will be appreciated that, while embodiments of the slack sensor and the slack sensing functionality are described herein in context of the data storage system (e.g., for detecting slack in cabling attached to the Z-platform assembly 410), similar or identical techniques can be applied in other contexts. Accordingly, descriptions of systems and methods in context of data storage environments are intended to provide context and clarity to the description, and should not be construed as limiting the scope of embodiments.

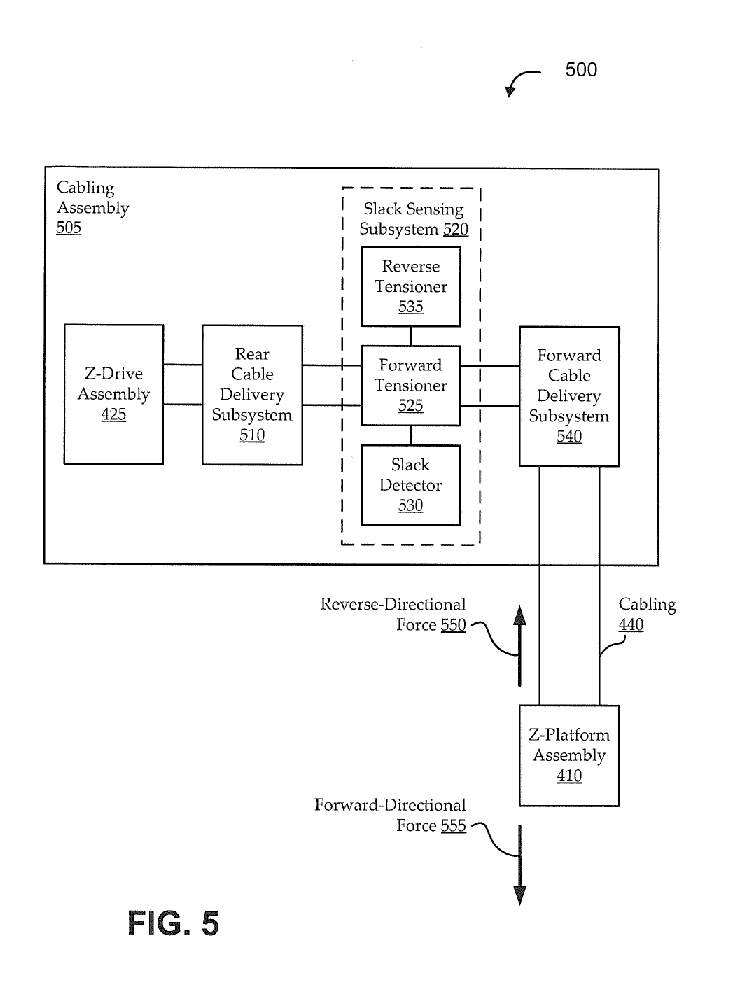

FIG. 5 shows a block diagram of an illustrative slack sensing environment 500, according to various embodiments. The illustrative environment 500 includes a cabling assembly 505 coupled with a Z-platform assembly 410, or the like, via one or more cables or other attachment means referred to herein as cabling 440. As discussed above, the Z-platform assembly 410 may include any kind of platform, carriage, or other structure. For example, the Z-platform assembly 410 may include a carriage configured to transport and support a robotic mechanism in the context of a data storage system. In some embodiments, the cabling 440 includes a cable attached at various attachment points (e.g., at each corner) of the Z-platform assembly 410. The cables may pass through a set of pulleys, guides, and/or other mechanisms to a Z-drive assembly 425. As described above, the Z-drive assembly 425 may include a bullwheel, gears, and/or other mechanisms for adding or releasing tension to the cabling 440, thereby raising or lowering the Z-platform assembly 410.

Embodiments of the cabling assembly 505 are configured to add or release tension to the cabling 440, or, alternatively, to add or release slack to the cabling 440. It is assumed in the context of embodiments that a forward directional force 555 is acting on the Z-platform assembly 410 in opposition to a reverse directional force 550 be maintained on or applied to the Z-platform assembly 410 by the cabling 440. For example, the forward directional force 555 may be the gravitational force acting in a downward direction on the Z-platform assembly 410, while the reverse directional force 550 is applied in a substantially upward direction via tension of the cabling 440. Alternatively, the forward directional force 555 may be applied in any direction by a magnetic field, a pressure wave (e.g., wind force, acoustical force, etc.), or the like, while the reverse directional force 550 is supplied by the cabling 440 substantially in opposition. The reverse directional force 550 can be used in such contexts to slow or prevent movement of the Z-platform assembly 410 in the direction of the forward directional force 555.

As illustrated, the cabling assembly 505 may include the Z-drive assembly 425, a rear cable delivery subsystem 510, a slack sensing subsystem 520, and a forward cable delivery system 540. For example, the cabling 440 passes from the Z-drive assembly 425 to the Z-platform assembly 410 via the other component subsystems of the cabling assembly 505. In some implementations, the rear cable delivery subsystem 510, the slack sensing subsystem 520, and the forward cable delivery system 540 are designed with pulleys, wheels, guides, and/or similar mechanisms to guide and/or since the condition of the cabling 440 without appreciably interfering with operations of the Z-drive assembly 425. For example, as cabling 440 is released to the system to lower the Z-platform assembly 410, the component subsystems of the cabling assembly 505 are configured substantially as “pass-throughs” for the one or more cables.

Embodiments of the slack sensing subsystem 520 are configured to detect slack manifest on one or more cables of the cabling 440. Implementations having multiple cables may use multiple slack sensing subsystems 522 detect slack on those cables (e.g., one slack sensing subsystem 520 in communication with each cable). As illustrated, the slack sensing subsystem 520 may include a forward tensioner 525, a slack detector 530, and a reverse tensioner 535. Embodiments are configured so that one or more cables of the cabling 440 pass through the forward tensioner 525. Reverse tension is maintained on the forward tensioner 525 by the reverse tensioner 535. The magnitude of reverse tension maintained by the reverse tensioner 535 is small enough to be easily overcome by opposing forces acting on the cabling 440 as a result of the forward directional force 555 when the cabling 440 is in tension. In this state, when the reverse tension is overcome by the cabling 440 being in tension, the forward tensioner 525 can be pulled into a “deactivated” state (e.g., a first position). Still, the magnitude of reverse tension maintained by the reverse tensioner 535 is large enough to hold the forward tensioner 525 in a normally “activated” state (e.g., a second position) when the cabling 440 is not in tension (i.e., when slack is manifest on the one or more cables passing through the forward tensioner 525).

According to the above, whenever a cable passing through the forward tensioner 525 is in tension, the forward tensioner 525 is pulled into its deactivated state; and whenever the cable passing through the forward tensioner 525 is not in tension (i.e., slack is manifest on the cable), the forward tensioner 525 reverts to its activated state. Embodiments of the rear cable delivery subsystem 510 and/or the forward cable delivery system 540 are configured to direct the cabling 440 to provide various functionality, including to direct the cabling 440 through the forward tensioner 525 in such a way as to facilitate operation of the forward tensioner 525 for slack detection. For example, the rear cable delivery system 510 is configured to direct one or more cables exiting the Z-drive assembly 425 to enter the forward tensioner 525 in a desired location, orientation, etc. Similarly, the forward cable delivery system 540 can be configured to direct the cabling to supply reverse directional force 550 and, concurrently, to translate any forward directional force 555 acting on the Z-platform assembly 410 into a cable tension in opposition to any reverse tension being applied on the forward tensioner 525 by the reverse tensioner 535.

Embodiments of the slack detector 530 are configured to detect when the forward tensioner 525 is in its activated state. For example, when slack is manifest on a cable passing through the forward tensioner 525, the forward tensioner 525 reverts to its activated state under force applied by the reverse tensioner 535, thereby triggering the slack detector 530. The slack detector 530 may be implemented in various different ways. In one implementation, when the forward tensioner 525 reverts to its activated state, the forward tensioner 525 comes in contact with a sensor component (e.g., or, alternatively, a sensor component on the forward tensioner 525 comes in contact with another feature). For example, when in the activated state, a portion of the forward tensioner 525 contacts a metallic pin creating an electrical coupling (e.g., a short circuit), covers or uncovers an optical sensor, or triggers any other type of sensor in any other detectable type of manner. In another implementation, movement of the forward tensioner 525 from the deactivated state to the activated state involves movement of at least a portion of the forward tensioner 525 around an axis, along a path, etc. in a manner that is detectable using a mechanical or electromechanical sensor component.

Embodiments of the slack detector 530 further include one or more components or subsystems for communicating the detected change of state as desired. For example, output of the sensor component is communicated in a wired or wireless fashion to one or more processors or controllers of the data storage system. Communication of the sensor output may additionally include any useful type of filtering, amplification, translation, etc. to allow the output results to be used by the system. For example, upon detection of slack in one or more cables of the cabling 440, the Z-drive assembly 425 may attempt to reel in the cables (e.g., lift the Z-platform assembly 410) past a point at which slack is no longer manifest on the cables and then to attempt letting out cabling again (e.g., lower the Z-platform assembly 410) hopefully without a repeated snag. Additionally or alternatively, upon detection of slack in one or more cables, the system may log the event, output an error indication, etc.

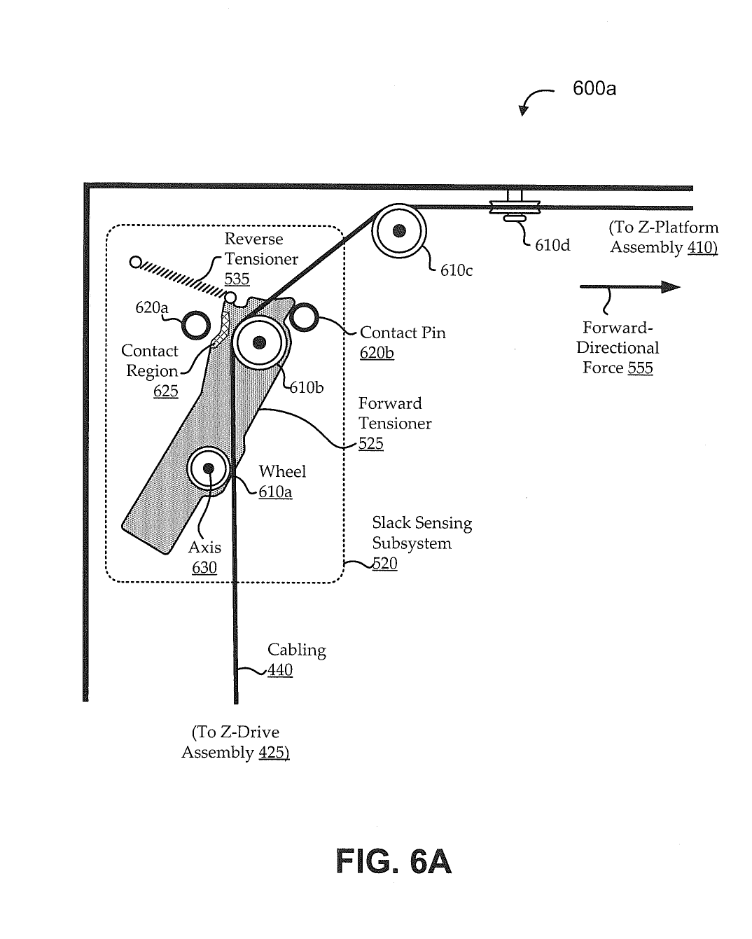

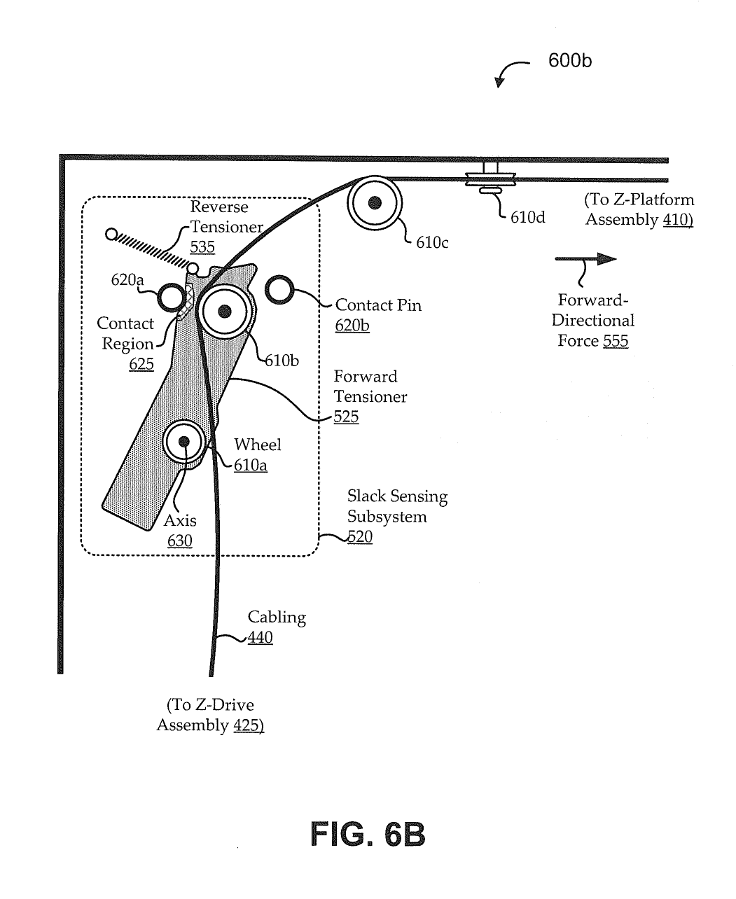

FIGS. 6A and 6B show two views of the same partial environment 600 to demonstrate operation of an illustrative slack sensing subsystem 520 in its deactivated and activated states, respectively, according to various embodiments. Turning first to FIG. 6A, it is assumed that no slack is manifest on the cabling 440 passing through the slack sensing subsystem 520, and the slack sensing subsystem 520 is shown in its activated environment, accordingly. As illustrated, the cabling 440 passes between the Z-drive assembly 425 and the Z-platform assembly 410 via a number of wheels 610. For example, wheel 610c and wheel 610d may be part of the forward cable delivery subsystem 540.

In the embodiment shown, the forward tensioner 525 is an assembly configured to rotate about axis 630, and its motion is restricted by contact pins 620. Forward directional force 555creates tension on the cabling 440 which is translated via one or more wheels 610 (e.g., at least wheel 610b) into a pulling force on forward tensioner 525. As described above, this pulling force is in a direction and of sufficient magnitude to overcome a pulling force in the other direction applied by reverse tensioner 535. The pulling force created by the forward directional force 555 causes the forward tensioner 525 to rotate about axis 630 until the rotation is halted by contact between the forward tensioner 525 and contact pin 620b. Notably, in this deactivated position, the cabling 440 can move substantially freely through the path formed by the various wheels 610 while also keeping a contact region 625 of the forward tensioner 525 pulled away from (i.e., out of contact with) contact pin 620a.

Turning FIG. 6B, an identical environment is shown with identical components, though the forward tensioner 525 is in its activated state. Accordingly, it is assumed that FIG. 6B illustrates an environment in which slack is manifest on the cabling 440 in such a way that is detectable by the slack sensing subsystem 520 (the cabling 440 is illustrated as having slack). A loss or reduction of forward directional force 555 translates into a loss or reduction of the cable tension pulling in a substantially clockwise manner on the forward tensioner 525. When the cable tension reduces below a particular threshold, it can no longer overcome the counterclockwise-directional pulling force acting on the forward tensioner 525 by the reverse tensioner 535. This counterclockwise-directional pulling force takes over, causing the forward tensioner 525 to rotate in a substantially counterclockwise manner around axis 630 until the rotation is halted by contact with contact pin 620a.

Notably, in this activated position, the contact region 625 of the forward tensioner 525 is in contact with contact pin 620a, in this contact can be detected as an indication of slack being manifest on the cabling 440. For example, contact between the contact region 625 in the contact pin 620a may complete an electrical circuit (e.g., pulling a signal to ground or to some detectable voltage level), or the like. In this way, the contact region 625 of the forward tensioner 525 and the contact pin 620a may act together as an embodiment of the slack detector 530 described above with reference to FIG. 5.

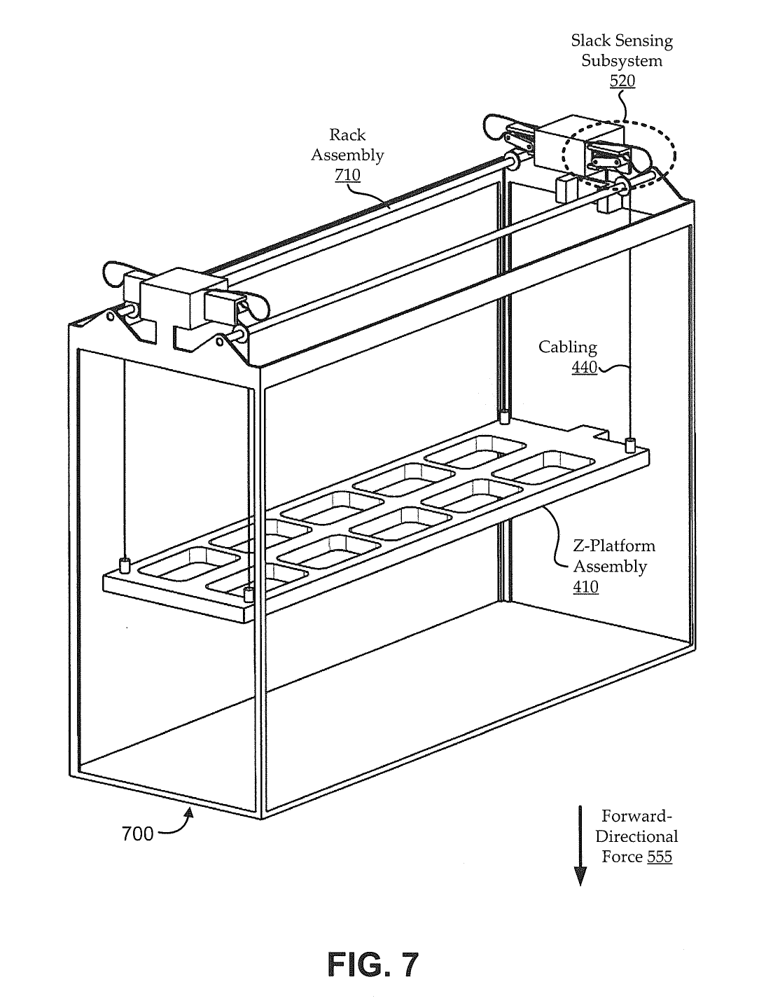

FIG. 7 shows an illustrative structural framework 700 within which a Z-platform assembly 410 can be raised and lowered using cabling 440 and slack in the cabling 440 can be detected using slack sensing subsystems 520 implemented according to various embodiments. The illustrative structural framework 700 may, for example, represent some of the structural features of one or more modules of a data storage system, such as those described with reference to FIGS. 1-4B. The structural framework 700 includes a rack assembly 710 that has various rails, pulleys, and/or the like for facilitating Z-directional movement of the Z-platform assembly 410 using the cabling 440.

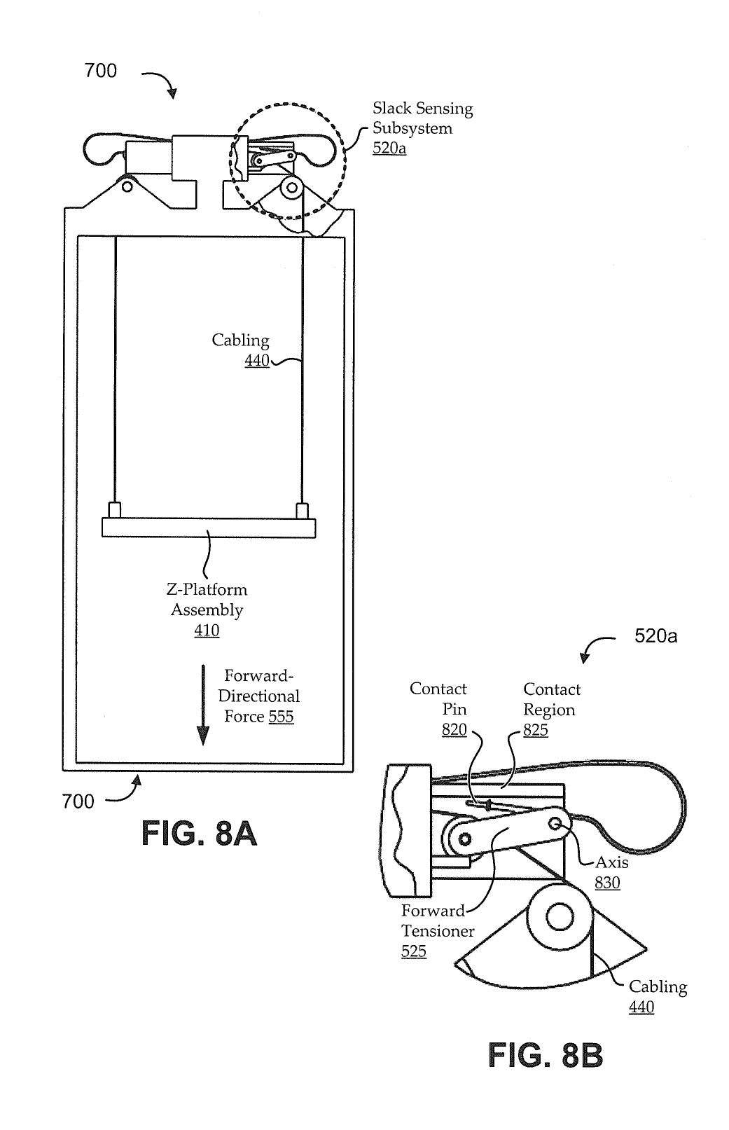

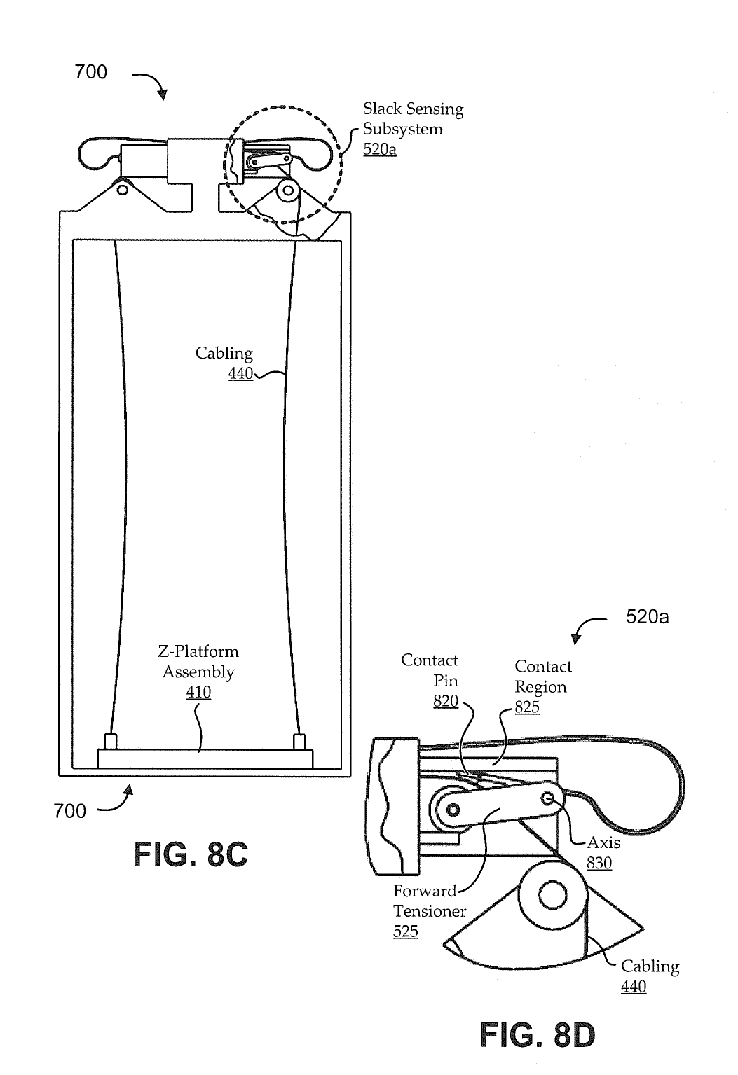

As shown, the cabling 440 includes four cables, one connected substantially at each corner of the Z-platform assembly 410. Each cable passes through its own slack sensing subsystem 520, each of which being configured to detect slack manifest on its respective cable. For example, if one corner of the Z-platform assembly 410 snags on a feature of the structural framework 700, at least the cable attached to the Z-platform assembly 410 in the vicinity of the snag will manifest slack, thereby activating its respective slack sensing subsystem 520. For the sake of adding clarity to the operation of certain embodiments of slack sensing subsystems 520, FIGS. 8A-8D show various views of the structural framework 700 of FIG. 7.

FIG. 8A shows a side view of the structural framework 700 of FIG. 7 in which one of the slack sensing subsystems 520a is revealed. FIG. 8B shows a close-up view of the slack sensing subsystem 520a revealed in FIG. 8A. As in FIG. 7, a Z-platform assembly 410 is shown hanging substantially freely on cabling 440 in the context of a structural framework 700, so that substantially no slack is manifest on any of the cables. In the embodiment shown, the slack sensing subsystem is configured so that the forward directional force 555 (i.e., the gravitational force pulling downward on the Z-platform assembly 410) creates tension in the cabling, which pulls downward on a forward tensioner 525 of the slack sensing subsystem 520. In this implementation, the downward force on the forward tensioner 525 maintains the forward tensioner 525 in its deactivated state.

The close-up view in FIG. 8B shows the forward tensioner 525 being pulled down by the cabling 440. The forward tensioner 525 is configured to rotate about axis 830. The forward tensioner 525 is coupled with a contact pin 820. When the cabling 440 is in tension, the forward tensioner 525 is pulled in a substantially counterclockwise direction about axis 830, thereby maintaining contact pin 820 out of contact with contact region 825. When contact pin 820 is not in contact with contact region 825, the slack sensing subsystem 520a is in its deactivated state.

FIG. 8C shows a similar side view of the structural framework 700 as shown in FIG. 8A with the same slack sensing subsystem 520a revealed, but with the cabling manifesting slack. FIG. 8D shows a close-up view of the slack sensing subsystem 520a revealed in FIG. 8C (i.e., in the activated state). Unlike in FIG. 8A, where the Z-platform assembly 410 is shown hanging substantially freely on cabling 440; the Z-platform assembly 410 is shown in FIG. 8C after having contacted the bottom of structural framework, so that slack is manifest in the cabling 440. Because the Z-platform assembly 410 is not freely hanging, the cabling 440 is not in tension, and there is no longer sufficient downward pulling force acting on the forward tensioner 525 of the slack sensing subsystem 520a.

The close-up view in FIG. 8D shows the forward tensioner 525 no longer being pulled down by the cabling 440. Though no reverse tensioner is shown, the slack sensing subsystem 520a is configured to have a reverse tension force acting in a substantially clockwise direction on the forward tensioner 525. For example, a spring may be installed at axis 830 creating a constant clockwise-directional force on the forward tensioner 525. In this implementation, when sufficient cable tension is no longer present to overcome the reverse tension force, the reverse tension force causes the forward tensioner 525 to rotate in a clockwise direction about axis 830, causing contact pin 820 come into contact with contact region 825.

When the contact pin 820 is in contact with contact region 825, the slack sensing subsystem 520 is in its activated state. As described above, contact between the contact pin 820 in the contact region 825 can be detected as an indication that slack is manifest in the cabling 440. As illustrated, the contact pin 820 and/or the contact region 825 may be coupled with a wire or other transmission means for communicating detection of slack in the cabling 442 one or more appropriate components (e.g. one or more processors or controllers).

It is worth noting that embodiments, such as the one illustrated in FIGS. 6A and 8D, can be designed to have low hysteresis. For example, implementations are designed with only a small displacement of the forward tensioner 525 between its deactivated state and its activated state. In this type of configuration, a small amount of slack manifest on the cabling 440 can cause (or allow) enough displacement to move the forward tensioner 525 to the activated state and to trigger slack detection. It is further worth noting that some implementations use low-hysteresis designs to provide indirect slack sensing. For example, the implementation shown in FIG. 7 includes a slack sensor on each of the four cables, but alternative implementations use fewer than four slack sensors to sense slack on all four cables.

In one such implementation, two slack sensors are configured so that each directly senses slack on a respective one of two cables. If one of the other two cables (i.e., that are not directly sensed by a slack sensor) manifests enough slack, some of that slack will cross-manifest on one of the directly sensed cables. For example, a larger displacement in the not-directly sensed cable will manifest a smaller, but sufficient amount of slack in one or both of the directly sensed cables. In this way, slack on any cable can be directly or indirectly sensed without providing a separate slack sensor for each cable. Notably, the hysteresis can be tuned to be large enough to avoid false positives (i.e., where there is no slack condition, but slack is detected), while being small enough to allow for indirect slack sensing before an excessive amount of slack is manifest on a not-directly sensed cable.

It will be appreciated that, while a number of different embodiments are described above, many modifications are possible without departing from the scope of these and other embodiments. For example, there may be many different ways to translate cable tension into a forward tension force acting on the forward tensioner 525, many different ways to provide an oppositional reverse tension force on the forward tensioner 525 to cause the forward tensioner 525 to move to its active state position one cable tension is not sufficiently present, many different ways to detect a transition of the forward tensioner 525 into its active state position, many different ways to communicate the detection for use by one or more other components of the environment, etc. Further, as discussed above, descriptions specifically referencing the Z-platform assembly 410 and/or other features of a data storage system are intended only to provide clarity and context and should not be construed as limiting the scope of embodiments. For example, similar techniques can be applied in any other context in which a force acting on an object in a direction creates a detectable amount of tension on cabling preventing or slowing movement of the object in that direction. Even further, as used herein, cabling is intended to broadly include any type of structure (e.g. including any shape, material, etc.) that can manifest slack or tension conditions. For example, the cabling may include belts, bands, chains, wires, ropes, cables, strands, tubes, etc.

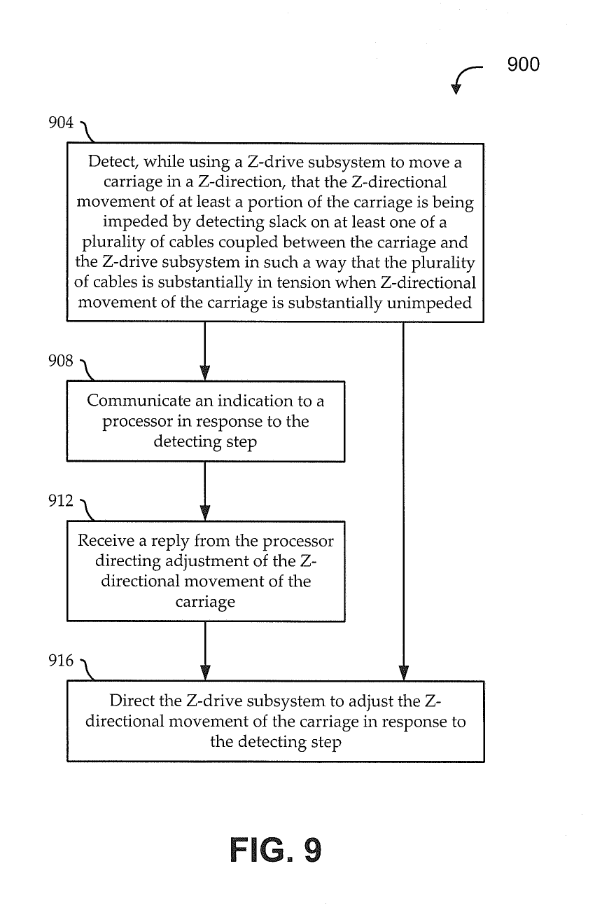

FIG. 9 shows a flow diagram of an illustrative method 900 for detecting slack, according to various embodiments. Embodiments of the method 900 began at stage 904 by detecting that Z-directional movement of at least a portion of a carriage is being impeded. As discussed above, the carriage is supported within a structural framework by one or more cables that couple the carriage with a Z-drive assembly configured to raise and lower the carriage on the cables (e.g., by winding or unwinding the cables on a bull wheel thereby taking in or letting out cable length and raising or lowering the carriage, accordingly). When Z-directional movement of the carriage is substantially unimpeded (e.g., when the carriage is allowed to hanging substantially freely within the structural framework under the force of gravity), tension is maintained on the cables so that the cables manifest no slack. Detecting, at stage 904, that Z-directional movement of the carriage is impeded involves detecting that slack is manifest on at least one of the cables coupled between the carriage and the Z-drive subsystem. For example, when the carriage is being raised or lowered, a portion of the carriage (e.g., a side or corner or feature of the carriage) may snag on a feature of the structural framework. This may interfere with Z-directional movement of at least that portion of the carriage, causing at least one of the cables to manifest slack.

In some embodiments, at stage 908, an indication that Z-directional movement of the carriage is impeded is communicated to a processor (e.g., any one or more processors, controllers, computational systems, etc.) in response to the detection at stage 904. As described above, the communication may occur in any useful way. For example, the indication may be communicated in a wired or wireless fashion, and/or using one or more techniques, such as amplifying, encoding, and/or otherwise affecting the data. Once received at the processor, the indication may be used in various ways, including to initiate an error log, a user prompt, etc.

In response to the indication, some embodiments receive a reply from the processor at stage 912. The reply from the processor may be configured to direct adjustment of the Z-directional movement of the carriage. For example, the Z-directional movement of the carriage may be adjusted by directing the carriage to stop moving at least in the Z-direction, to move by some amount in the opposite direction, to slow down its movement, etc. The reply may be received from the processor over the same channel as, or over a different channel from, the wired or wireless channel used to send the indication. Similarly, the reply may be received from the processor using the same, similar, or different data processing and/or communication techniques as those used to communicate the indication.

At stage 916, embodiments direct the Z-drive subsystem to adjust the Z-directional movement of the carriage in response to detecting impeded movement at stage 904. In some implementations, components that detect impedance to the movement of the carriage at stage 904 are in direct communication with the Z-drive subsystem in such a way that the Z-drive subsystem can adjust the Z-directional movement of the carriage directly in response to the detection of impeded Z-directional movement. In other implementations, the Z-drive subsystem is in communication with the processor and is configured to adjust the Z-directional movement of the carriage in response to the reply received from the processor at stage 912.

It will be appreciated that the Z-drive subsystem can be configured to respond to impeded Z-directional movement of the carriage in various ways. In some implementations, the response is simply to halt Z-directional movement of the carriage and to output an error indication. In other implementations, the response is to reverse or otherwise change the Z-directional movement of the carriage (e.g. or to change movement of other portions of the carriage, such as by moving a robotic mechanism disposed on the carriage to a different location on the carriage) in an attempt to “un-snag” the carriage, thereby removing any impedance to its Z-directional movement. In still other implementations, slack sensing and/or any other kind of sensing (e.g., tilt sensing, accelerometer sensing, position sensing, etc.) can be used to obtain more information about any root causes of impedance to the Z-directional movement of the carriage. The same or other sensing can also be used in yet other implementations to monitor any attempted changes in the Z-directional movement of the carriage to help automatically address the impedance.

As discussed above, similar or identical techniques can be used in a variety of contexts and with a variety of modifications without departing from the scope of embodiments. For example, the structural framework may be internal structure of one or more modules of the data storage system, such as the various types of data storage systems discussed above. In those contexts, the carriage may be the Z-platform assembly, which acts as a carriage to the data storage system's robotic mechanism. Alternatively, the carriage may be any type of platform, set of rails, or other structural component or system that is substantially “suspended” within a field on one or more cables that are normally in tension as a result of the field's effect on the carriage. Further, terms like “hanging,” “raised,” “lowered,” “suspended,” “Z-directional,” and the like are intended to be construed in relation to the type of field acting on the carriage. For example, in implementations where the carriage includes structure hanging in a normal gravitational field, the carriage may be hanging as a result of being pulled vertically downward by the gravitational field. In that context, raising or lowering, or otherwise moving the carriage in a Z-direction, may suggest moving the carriage vertically with respect to the gravitational field. In other implementations where the carriage includes magnetic material hanging in a magnetic field, the magnetic material may, in fact, be “hanging” in any direction as dictated by the direction of the magnetic field. In that context, raising or lowering, or otherwise moving the carriage in a Z-direction, may suggest moving the carriage substantially in the direction of or in opposition to the net magnetic field pulling on the carriage.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The various operations of methods and functions of certain system components described above may be performed by any suitable means capable of performing the corresponding functions. The means may include various hardware and/or software component(s) and/or module(s), including, but not limited to a circuit, an application specific integrated circuit (ASIC), or processor. For example, logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm or other functionality described in connection with the present disclosure, may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A slack sensing system comprising:
a forward tensioner in mechanical communication with a cable and configured to manifest a deactivated state when the cable is manifesting a tension condition and an activated state when the cable is manifesting a slack condition;
a reverse tensioner configured to apply a reverse force on the forward tensioner;
a forward cable delivery subsystem configured to translate tension on the cable into a forward force acting on the forward tensioner in such a way that the forward force is of a magnitude sufficient to overcome the reverse force applied by the reverse tensioner when the cable is manifesting the tension condition and insufficient to overcome the reverse force applied by the reverse tensioner when the cable is manifesting the slack condition; and
a slack detector configured to detect when the forward tensioner is in the activated state.

2. The slack sensing system of claim 1, wherein the reverse tensioner comprises a spring configured to apply the reverse force on the forward tensioner as spring tension.

3. The slack sensing system of claim 1, wherein the slack detector is configured to detect when the forward tensioner is in the activated state by detecting that the forward tensioner is not in the deactivated state.

4. The slack sensing system of claim 1, wherein:
the forward tensioner comprises a first contact region configured to be in contact with a second contact region when the forward tensioner is in the activated state; and
the slack detector is configured to detect when the forward tensioner is in the activated state by detecting that the first contact region of the forward tensioner is in contact with the second contact region.

5. The slack sensing system of claim 1, further comprising:
a switch configured to be in a first switch state when the forward tensioner is in the deactivated state and to be in a second switch state when the forward tensioner is in the activated state,
wherein the slack detector is configured to detect when the forward tensioner is in the activated state by detecting that the switch is in the second switch state.

6. The slack sensing system of claim 1, further comprising:
a communications subsystem in operative communication with the slack detector and a processor, and configured to communicate a slack detected indication to the processor in response to the slack detector detecting that the forward tensioner is in the activated state.

7. The slack sensing system of claim 1, wherein:
the cable is a first cable of a plurality of cables coupled with a carriage;
at least a second cable of the plurality of cables is not in mechanical communication with the forward tensioner; and
the forward tensioner is configured to have low enough hysteresis so that an allowable threshold of slack manifest in the second cable cross-manifests enough slack in the first cable to move the forward tensioner to the activated state.

8. The slack sensing system of claim 1, wherein the forward tensioner is as a pass-through for the cable.

9. The slack sensing system of claim 1, wherein the cable couples a drive assembly to a carriage assembly and the tension on the cable is due at least in part by gravitational forces acting on the carriage assembly.

10. A carriage transport system comprising:
a structural framework;
a carriage configured to travel in a Z-direction in context of the structural framework;
a Z-drive subsystem comprising:
a plurality of cables coupled with the carriage in such a way that the plurality of cables are in tension when Z-directional movement of the carriage is substantially unimpeded; and
a drive mechanism configured to move the carriage in the Z-direction using the cables; and
a slack sensing subsystem in mechanical communication with at least one of the cables and configured to detect that the Z-directional movement of at least a portion of the carriage is being impeded by detecting slack on the at least one of the cables.

11. The carriage transport system of claim 10, wherein the slack sensing subsystem is one of a plurality of slack systems, each of the plurality of slack systems is in mechanical communication with a respective one of the plurality of cables.

12. The carriage transport system of claim 10, wherein the carriage hangs substantially freely on the cables when the Z-directional movement of the carriage is substantially unimpeded, thereby maintaining the plurality of cables in tension.

13. The carriage transport system of claim 10, wherein the Z-drive subsystem is further configured to adjust the Z-directional movement of the carriage in response to the slack sensing subsystem detecting that the Z-directional movement of at least a portion of the carriage is being impeded by detecting slack on the at least one of the cables.

14. The carriage transport system of claim 10, further comprising:
a communications subsystem in operative communication with the slack sensing subsystem and a processor, and configured to communicate a slack detected indication to the processor in response to the slack sensing subsystem detecting that the Z-directional movement of at least a portion of the carriage is being impeded by detecting slack on the at least one of the cables.

15. The carriage transport system of claim 14, wherein:
the communications subsystem is further in operative communication with the Z-drive subsystem, and is further configured to:
receive a reply from the processor in response to communicating the slack detected indication; and
direct the Z-drive subsystem to adjust the Z-directional movement of the carriage in response to the reply.

16. The carriage transport system of claim 10, wherein the slack sensing subsystem comprises:
triggering means configured to operate in an activated or a deactivated state;
forward tensioner means for translating tension on the at least one cable into a first force acting on the triggering means in such a way that the triggering means operates in the deactivated state in response to the first force when the at least one cable is manifesting a tension condition;
reverse tensioner means for applying a second force acting on the triggering means in opposition to the first force in such a way that the triggering means operates in the activated state in response to the second force when the at least one cable is manifesting a slack condition; and
a detection means for detecting when the triggering means is in the activated state.

17. The carriage transport system of claim 10, wherein the slack sensing subsystem comprises:
a forward tensioner in mechanical communication with the at least one cable and configured to manifest a deactivated state when the cable is manifesting a tension condition and an activated state when the cable is manifesting a slack condition;
a reverse tensioner configured to apply a reverse force on the forward tensioner;
a forward cable delivery subsystem configured to translate tension on the cable into a forward force acting on the forward tensioner in such a way that the forward force is of a magnitude sufficient to overcome the reverse force applied by the reverse tensioner when the cable is manifesting the tension condition and insufficient to overcome the reverse force applied by the reverse tensioner when the cable is manifesting the slack condition; and
a slack detector configured to detect when the forward tensioner is in the activated state.

18. The carriage transport system of claim 17, wherein:
the forward tensioner comprises a first contact region configured to be in contact with a second contact region when the forward tensioner is in the activated state; and
the slack detector is configured to detect when the forward tensioner is in the activated state by detecting that the first contact region of the forward tensioner is in contact with the second contact region.

19. A method for controlling Z-directional movement of a carriage in context of a structural framework, the method comprising:
detecting, while using a Z-drive subsystem to move a carriage in a Z-direction, that the Z-directional movement of at least a portion of the carriage is being impeded by detecting slack on at least one of a plurality of cables coupled between the carriage and the Z-drive subsystem in such a way that the plurality of cables is substantially in tension when Z-directional movement of the carriage is substantially unimpeded; and
directing the Z-drive subsystem to adjust the Z-directional movement of the carriage in response to the detecting step.

20. The method of claim 19, wherein the detecting step comprises detecting that a slack sensor in mechanical communication with the at least one cable is in an activated position, the slack sensor configured to be moved to a deactivated position when the at least one cable is manifesting a tension condition and to be moved to the activated position when the at least one cable is manifesting a slack condition.
